(19) United States
(12) Patent Application Publication
(10) Pub. No.: US 2026/0274182 A1
(43) Pub. Date: Sep. 17, 2026

(54) SCHEDULING APPARATUS, CONTROL METHOD, AND CONTROL PROGRAM

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventor: Takayuki SHIOZAWA, Yokkaichi-shi, Mie (JP)

(73) Assignees: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(21) Appl. No.: 19/469,147

(22) PCT Filed: Mar. 21, 2024
(86) PCT No.: PCT/JP2024/011041

§ 371 Date: Sep. 25, 2025

(30) Foreign Application Priority Data
Mar. 28, 2023 (JP) 2023-051830

(51) Int. Cl. B60R 16/023; H04L 12/40

(52) U.S. Cl. CPC B60R 16/023; H04L 12/4015; H04L 2012/40273

(57) ABSTRACT

A scheduling apparatus includes: a scheduling apparatus that schedules functions executed by a plurality of vehicle-mounted control apparatuses that communicate with each other via a communication bus, an acquisition unit that acquires first information, which determines first execution start timing, and a first execution period, which is a period at which the first function is executed, and second information, which determines a second execution start timing; and a determination unit that determines, based on the first information and the second information, the first execution start timing, the first execution period, the second execution start timing, and the second execution period, which minimize total power consumption of the first vehicle-mounted control apparatus, the second vehicle-mounted control apparatus, and the third vehicle-mounted control apparatus.

### CROSS-REFERENCE TO RELATED APPLICATIONS

This application is the U.S. national stage of PCT/JP2024/011041 filed on Mar. 21, 2024, which claims priority of Japanese Patent Application No. JP 2023-051830 filed on Mar. 28, 2023, the contents of which are incorporated herein.

### TECHNICAL FIELD

The present disclosure relates to scheduling apparatus, a control method, and a control program.

### BACKGROUND

Vehicles are equipped with various types of vehicle-mounted apparatuses, such as control system ECUs (Electronic Control Units) that control the engine, the transmission, and the like, vehicle system ECUs that control the headlights, power windows, and the like, and information system ECUs for a navigation apparatus, multimedia devices, and the like.

JP 2006-151007A discloses a sleep control system for an automobile where sleep periods differ between a plurality of applications, the system having a sleep control information acquisition means acquire information relating to a requested sleep period individually from each application and an effective sleep period calculation means discover a period that is commonly included in the acquired requested sleep periods as an effective sleep period and then use the effective sleep period to perform sleep and wake-up control of objects subjected to hardware control.

However, the automobile sleep control system according to JP 2006-151007A defines the effective sleep period as a period that is commonly included in the requested sleep periods of each application, so that as the number of applications executed in parallel increases, the sleep period becomes shorter, resulting in the problem that it becomes difficult to suppress power consumption.

### SUMMARY

A scheduling apparatus according to an aspect of the present disclosure is a scheduling apparatus for scheduling functions executed by a plurality of vehicle-mounted apparatuses that are capable of communicating with each other via a communication bus, the scheduling apparatus including: an acquisition unit that acquires first information, which determines first execution start timing, which is timing at which a first function executed by a first vehicle-mounted control apparatus and a second vehicle-mounted control apparatus is started, and a first execution period, which is a period at which the first function is executed, and second information, which determines a second execution start timing, which is timing at which a second function executed by the first vehicle-mounted control apparatus and a third vehicle-mounted control apparatus is started, and a second execution period, which is a period at which the second function is executed; and a determination unit that determines, based on the first information and the second information, the first execution start timing, the first execution period, the second execution start timing, and the second execution period, which minimize total power consumption of the first vehicle-mounted control apparatus, the second vehicle-mounted control apparatus, and the third vehicle-mounted control apparatus.

The present disclosure can be realized not only as a scheduling apparatus with the characteristic configuration described above, a control method with steps corresponding to characteristic processes in the scheduling apparatus, and a control program for causing the vehicle-mounted control apparatus to execute the characteristic processes, but also with some or all of such vehicle-mounted control apparatuses as semiconductor integrated circuits.

### Advantageous Effects of Invention

According to the present disclosure, it is possible to suppress the power consumption of vehicle-mounted control apparatuses, even when the number of functions executed in parallel increases.

### BRIEF DESCRIPTION OF DRAWINGS

FIG. 1 is a block diagram depicting one example configuration of a vehicle-mounted system including a scheduling apparatus according to a first embodiment.

FIG. 2 is a block diagram depicting an example configuration of a GW according to the first embodiment.

FIG. 3 is a block diagram depicting an example configuration of an ECU according to the first embodiment.

FIG. 4 is one example of a cluster table depicting the clusters to which each ECU belongs.

FIG. 5 is a functional block diagram depicting example functions of a GW according to the first embodiment.

FIG. 6 is a diagram depicting one example of information for determining execution start timing and an execution period.

FIG. 7 is a diagram depicting the operation when two functions are executed in parallel.

FIG. 8 is a diagram depicting the operation when two functions are executed simultaneously.

FIG. 9 is a diagram depicting the operation when two functions are executed with different execution periods.

FIG. 10 is a diagram depicting an operation where two functions are executed simultaneously with the same execution period.

FIG. 11 is a flowchart depicting an example of the operation of a scheduling apparatus according to the first embodiment.

FIG. 12 is a flowchart depicting one example of a routine for determining the execution start timing and the execution period.

FIG. 13 is a functional block diagram depicting example functions of a scheduling apparatus according to a second embodiment.

FIG. 14 is a flowchart depicting an example operation of the scheduling apparatus according to the second embodiment.

FIG. 15 is a diagram depicting one example of execution condition information including limit information.

FIG. 16 is a diagram depicting an example order of execution of first to third functions.

FIG. 17 is a diagram depicting one example of the order of execution of the first to third functions.

FIG. 18 is a flowchart depicting one example of the operation of the scheduling apparatus according to a third embodiment.

### DETAILED DESCRIPTION OF PREFERRED EMBODIMENTS

Several embodiments of the present disclosure will first be listed and described in outline.

In a first aspect, a scheduling apparatus according to an aspect of the present disclosure is a scheduling apparatus for scheduling functions executed by a plurality of vehicle-mounted apparatuses that are capable of communicating with each other via a communication bus, the scheduling apparatus including: an acquisition unit that acquires first information, which determines first execution start timing, which is timing at which a first function executed by a first vehicle-mounted control apparatus and a second vehicle-mounted control apparatus is started, and a first execution period, which is a period at which the first function is executed, and second information, which determines a second execution start timing, which is timing at which a second function executed by the first vehicle-mounted control apparatus and a third vehicle-mounted control apparatus is started, and a second execution period, which is a period at which the second function is executed; and a determination unit that determines, based on the first information and the second information, the first execution start timing, the first execution period, the second execution start timing, and the second execution period, which minimize total power consumption of the first vehicle-mounted control apparatus, the second vehicle-mounted control apparatus, and the third vehicle-mounted control apparatus. By doing so, it is possible to suppress the power consumption of the vehicle-mounted control apparatuses even if the number of functions executed in parallel increases.

In a second aspect, the scheduling apparatus according to the first aspect further includes a setting unit for setting the first execution start timing and the first execution period determined by the determination unit in the first vehicle-mounted control apparatus and the second vehicle-mounted control apparatus and setting the second execution start timing and the second execution period determined by the determination unit in the first vehicle-mounted control apparatus and the third vehicle-mounted control apparatus. By doing so, it is possible to suppress the power consumption of the vehicle-mounted control apparatuses even if the number of functions executed in parallel increases.

In a third aspect, the scheduling apparatus according to the first or the second aspect, the determination unit determines a first setting range, which is a range in which the first execution period is to be limited, based on the first information, determines the first execution start timing and the first execution period based on the first setting range, determines a second setting range, which is a range in which the second execution period is to be limited, based on the second information, and determines the second execution start timing and the second execution period based on the second setting range. By doing so, it is possible to determine the execution periods of functions within a range in which the execution periods should be limited and execute the first function and the second function in an overlapping manner. As a result, it is possible to suppress the power consumption of the vehicle-mounted control apparatuses, even if the number of functions executed in parallel increases.

In a fourth aspect, the scheduling apparatus according to the third aspect, the first setting range is decided based on a first period initial value, which is an initial value of a period at which the first function is executed, and a first tolerated range, which is a range in which a change from the first period initial value is tolerated, and the second setting range is decided based on a second period initial value, which is an initial value of a period at which the second function is executed, and a second tolerated range, which is a range in which a change from the second period initial value is tolerated. By doing so, it is possible to determine the execution periods based on the initial values of the periods and the tolerated ranges and to execute the first function and the second function in an overlapping manner. As a result, it is possible to suppress the power consumption of the vehicle-mounted control apparatuses even if the number of functions executed in parallel increases.

In a fifth aspect, in the scheduling apparatus according to the fourth aspect, the first information includes a first execution duration that is a time from when the first function is started to when the first function ends in the first execution period, and the second information includes a second execution duration that is a time from when the second function is started to when the second function ends in the second execution period. By doing so, it is possible for the first and second functions to be executed in an overlapping manner in terms of the time width, which enables the execution period and timing to be flexibly determined.

In a sixth aspect, in the scheduling apparatus according to the fifth aspect, the determination unit calculates power consumption of each of the first vehicle-mounted control apparatus, the second vehicle-mounted control apparatus, and the third vehicle-mounted control apparatus based on the first execution duration and the second execution duration, and determines the first execution start timing, the first execution period, the second execution start timing, and the second execution period that minimize the total power consumption. By doing so, it is easy to calculate the total power consumption.

In a seventh aspect, in a scheduling apparatus according to any one of the first to the sixth aspect, the first information includes information indicating a limit condition that limits execution of the first function, and the determination unit determines the first execution start timing, the first execution period, the second execution start timing, and the second execution period to avoid the limit condition. By doing so, it is possible to calculate a schedule that can suppress power consumption of vehicle-mounted control apparatuses even when there is a condition that limits the execution of a function.

In an eighth aspect, in the scheduling apparatus according to the seventh aspect, the limit condition includes a condition that limits execution of the first function and execution of the second function from overlapping on a time axis. By doing so, it is possible to calculate a schedule that can suppress power consumption of vehicle-mounted control apparatuses, even when overlapping execution of functions is restricted.

In a ninth aspect, in the scheduling apparatus according to the sixth aspect, the limit condition includes at least one of a condition relating to a restriction on hardware resources used by the first function and a condition relating to a restriction on hardware resources used by the second function. By doing so, it is possible to calculate a schedule that can reduce the power consumption of the vehicle-mounted control apparatuses even if there are limitations on the hardware resources that functions can use.

In a tenth aspect, a control method according to an aspect of the present disclosure is a control method for use by a scheduling apparatus that schedules functions executed by a plurality of vehicle-mounted apparatuses that are capable of communicating with each other via a communication bus, the control method including: a step of acquiring first information, which determines first execution start timing, which is timing at which a first function executed by a first vehicle-mounted control apparatus and a second vehicle-mounted control apparatus is started, and a first execution period, which is a period at which the first function is executed, and second information, which determines a second execution start timing, which is timing at which a second function executed by the first vehicle-mounted control apparatus and a third vehicle-mounted control apparatus is started, and a second execution period, which is a period at which the second function is executed; and a step of determining, based on the first information and the second information, the first execution start timing, the first execution period, the second execution start timing, and the second execution period, which minimize total power consumption of the first vehicle-mounted control apparatus, the second vehicle-mounted control apparatus, and the third vehicle-mounted control apparatus. By doing so, it is possible to suppress the power consumption of the vehicle-mounted control apparatuses even if the number of functions executed in parallel increases.

In an eleventh aspect, a control program according to an aspect of the present disclosure is a control program used by a scheduling apparatus that schedules functions executed by a plurality of vehicle-mounted apparatuses that are capable of communicating with each other via a communication bus, the control program causing a computer to execute processing including: a step of acquiring first information, which determines first execution start timing, which is timing at which a first function executed by a first vehicle-mounted control apparatus and a second vehicle-mounted control apparatus is started, and a first execution period, which is a period at which the first function is executed, and second information, which determines a second execution start timing, which is timing at which a second function executed by the first vehicle-mounted control apparatus and a third vehicle-mounted control apparatus is started, and a second execution period, which is a period at which the second function is executed; and a step of determining, based on the first information and the second information, the first execution start timing, the first execution period, the second execution start timing, and the second execution period, which minimize total power consumption of the first vehicle-mounted control apparatus, the second vehicle-mounted control apparatus, and the third vehicle-mounted control apparatus. By doing so, it is possible to suppress the power consumption of the vehicle-mounted control apparatuses even if the number of functions executed in parallel increases.

### 1. First Embodiment

Preferred embodiments of the present disclosure are described in detail below with reference to the accompanying drawings. Note that the embodiments described below can be freely combined, at least in part.

### 1-1. Vehicle-Mounted System

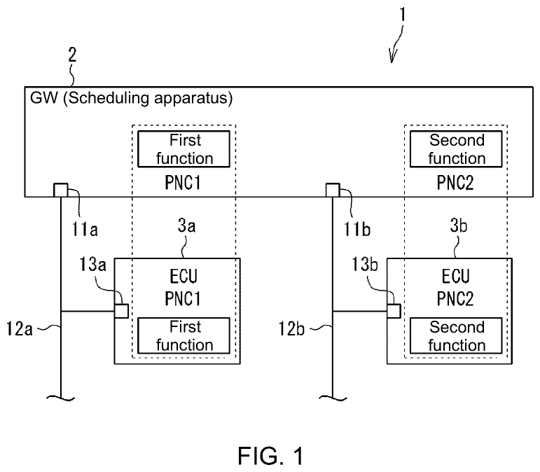

FIG. 1 is a block diagram depicting one example configuration of a vehicle-mounted system including a scheduling apparatus according to a first embodiment. The vehicle-mounted system 1 is mounted in a vehicle. The scheduling apparatus schedules execution timing of functions executed by a plurality of vehicle-mounted control apparatuses that can communicate with each other via a communication bus. As one example, the scheduling apparatus is realized as a gateway (hereinafter indicated as “GW”) that is in overall control of individual vehicle-mounted control apparatuses (hereinafter simply indicated as “ECUs”) that execute predetermined functions. A gateway is itself one type of ECU and is sometimes referred to as an “integrated ECU”. A scheduling apparatus can also be realized as a server that is external to the vehicle. The following describes a gateway as one example of a scheduling apparatus.

The vehicle-mounted system 1 according to the first embodiment includes a GW 2, an ECU 3a, and an ECU 3b. The vehicle-mounted system 1 is a vehicle-mounted network including the integrated ECU 2, the ECU 3a, the ECU 3b, and communication cables (or “communication buses”) that connect the integrated ECU 2, the ECU 3a, and the ECU 3b. Note that the ECU 3a and the ECU 3b may be collectively referred to below as the “ECUs 3”.

A plurality of ECUs 3 are disposed in various parts of the vehicle. The ECUs 3 individually control the hardware at each part of the vehicle and/or monitor the state of the hardware at each part of the vehicle. As examples, the ECUs 3 are ECUs for control systems, the vehicle body, and information systems.

The GW 2 is connected to each of the ECUs 3 via communication buses 12a and 12b, such as Controller Area Network (CAN) buses. In more detail, the GW 2 includes communication interfaces (or “communication I/Fs”) 11a and 11b. The communication I/F 11a is connected to the communication bus 12a. The ECU 3a is connected to this communication bus 12a. The communication I/F 11b is connected to the communication bus 12b. The ECU 3b is connected to this communication bus 12b. The GW 2 is capable of bidirectional communication with each of the ECUs 3.

The ECUs 3 include communication I/Fs 13a and 13b connected to the communication buses. The communication I/Fs 13a and 13b are I/Fs that are compatible with a partial networking function. When a partial networking function is used, the GW 2 and the ECUs 3 use a communication protocol that is compatible with the partial networking function. Example communication protocols include CAN, CAN FD (CAN with Flexible Data Rate), and CAN PN (CAN with Partial Networking).

Partial networking is a function in a vehicle-mounted system in which each vehicle-mounted apparatus is connected via a bus network, where the vehicle-mounted apparatuses are divided into clusters called partial networking clusters (PNCs) for each function (service), the vehicle-mounted apparatuses of a PNC used to execute a service are woken up, and the vehicle-mounted apparatuses of the other PNCs are put to sleep.

The GW 2 has a function as a gateway that relays communication between the ECUs 3. The GW 2 and the ECUs 3 can transmit frames. The GW 2 relays frames between ECUs connected to different buses. As one example, the GW 2 can relay frames between the ECU 3a connected to the communication bus 12a and the ECU 3b connected to the communication bus 12b. By doing so, it is possible to transmit and receive frames between the ECU 3a connected to the communication bus 12a and the ECU 3b connected to the communication bus 12b, for example.

### 1-2. Configuration of GW

The hardware configuration of the GW 2 is described below.

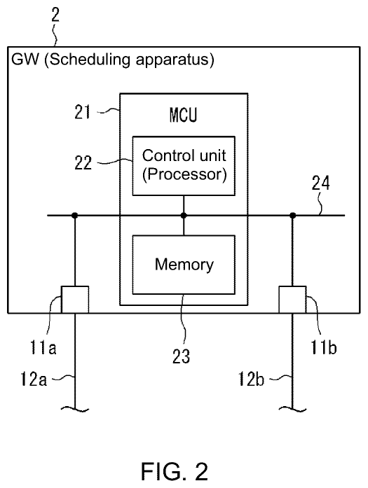

FIG. 2 is a block diagram depicting an example configuration of the GW 2 according to the first embodiment. The GW 2 includes a microcontroller unit 21 (hereinafter referred to as the “MCU 21”), which includes a control unit 22 and a memory 23, and the plurality of communication I/Fs 11a and 11b. The control unit 22, the memory 23, and the communication I/Fs 11a and 11b are electrically connected by an internal bus 24.

The control unit 22 includes a circuit configuration, such as a processor. In more detail, the control unit 22 includes one or more central processing units (CPUs). The processor included in the control unit 22 may be a graphics processing unit (GPU). With this configuration, the control unit 22 reads out a computer program stored in the memory 23 and executes various computation and control.

The control unit 22 may include a processor in which a predetermined program has been written in advance. As examples, the control unit 22 may be an integrated circuit such as a Complex Programmable Logic Device (CPLD), a Field-Programmable Gate Array (FPGA), or an Application Specific Integrated Circuit (ASIC). In this case, the control unit 22 executes various computation and control based on a program written in advance.

The memory 23 includes a volatile memory and a non-volatile memory, and stores various data. As examples, the volatile memory includes RAM (Random Access Memory). Examples of non-volatile memory include flash memory, a hard disk drive (HDD), a solid state drive (SSD), or read only memory (ROM). Part of the non-volatile memory may be provided outside the MCU 21.

As one example, the memory 23 stores, in the non-volatile memory, computer programs, information, which will be described later, for determining execution timing of functions to be executed by the ECUs, and various parameters. The memory 23 may also store computer programs that have been downloaded from an external device (not illustrated) via a network (not illustrated) and a communication apparatus (not illustrated).

The communication I/Fs 11a and 11b receive signals present on the communication buses 12a and 12b via separate ports (not depicted) and convert the signals into signals that the MCU 21 is capable of reading. The communication I/Fs 11a and 11b are connected to the communication buses 12a and 12b, respectively.

### 1-3. Configuration of ECU

The hardware configuration of the ECUs 3 is described below.

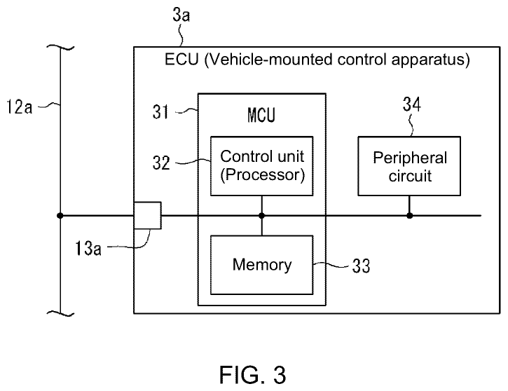

FIG. 3 is a block diagram depicting an example configuration of an ECU according to the first embodiment. The ECU 3a includes a microcontroller unit 31, the communication I/F 13a, and a peripheral circuit 34. The ECU 3b has the same configuration as the ECU 3a.

The microcontroller unit 31 (hereinafter referred to as the “MCU 31”) has the same configuration as the MCU 21 of the GW 2 described earlier. That is, the MCU 31 includes a control unit (processor) 32 and a memory 33 including non-volatile memory and volatile memory. The MCU 31 may also include a peripheral circuit 34 and the communication I/F 13a.

The memory 33 stores a control program, which is a computer program, and data used to execute the control program. The control program can be stored on a recording medium, such as flash memory, a ROM, or a CD-ROM. With this control program, the processor 32 enables the ECU 3a to use partial networking.

As examples, the peripheral circuit 34 includes a serial communication circuit that conforms to a standard such as UART, I2C, and SPI. The serial communication circuit of the peripheral circuit 34 is connected to a device or sensor that is to be controlled by the ECU 3a, and can receive signals that is output from the sensor and transmit control signals to the object to be controlled.

The communication I/F 13a is a communication interface that conforms to the communication protocol for a vehicle-mounted network mentioned above. The communication I/F 13a is compatible with partial networking.

### 1-4. Clusters

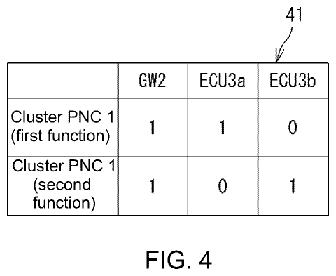

FIG. 4 is one example of a cluster table depicting the clusters to which each ECU belongs, for a case where ECUs belong to clusters. Clusters are described below. The “clusters” referred to here are the PNC mentioned earlier. Each ECU 3 belongs to at least one cluster. The memory 23 of the GW 2 stores a cluster table 41 that links the ECUs 3 with the clusters to which each ECU 3 belongs. The cluster table 41 may be stored in each of the ECUs 3.

Examples of the functions executed by a plurality of ECUs include a periphery monitoring function that uses an image sensor (hereinafter referred to as the “periphery monitoring function”) and a vehicle information gathering function.

Periphery monitoring is performed by the ECU 3a and the GW 2. For this reason, the image ECU and the GW 2 belong to the same cluster. The ECU 3a executes a function (or “first function a”) of acquiring an image from an image sensor that captures the periphery of the vehicle and transmits a frame including the acquired image to the GW 2. The GW 2 receives this frame including an image transmitted from the image ECU, and executes a function (or “first function b”) of recognizing people in the received image.

The vehicle information gathering function is executed for example by the GW 2 and the ECU 3b. For this reason, the GW 2 and the ECU 3b belong to the same cluster. The GW 2 executes a function (or “second function a”) in which the GW 2 receives predetermined vehicle information from predetermined ECUs via the communication buses 12a and 12b and transmits a frame including the received vehicle information to the ECU 3b. The ECU 3b, which is a telematic control unit (TCU), executes a function (or “second function b”) of receiving the frame including vehicle information transmitted from the GW 2 and uploading the received vehicle information to a server outside the vehicle. The vehicle information gathered here may include the voltage of the battery the engine rpm detected by an engine tachometer, and the like.

The cluster table 41 depicted in FIG. 4 indicates which GWs and ECUs belong to each of two clusters PNC 1 and PNC 2. Note that the number of clusters in FIG. 4 is merely one example, and two or more clusters may be provided. In the table, “1” indicates that the GW or an ECU belongs to the cluster on that row, and “0” indicates that the GW or an ECU does not belong to the cluster on that row.

As one example, the GW 2 and the ECU 3a belong to the cluster PNC 1. The GW 2 and the ECU 3a that belong to the cluster PNC 1 execute a first function, for example, a periphery monitoring function. The GW 2 and the ECU 3b belong to the cluster PNC 2. As one example, the second function is a vehicle information gathering function executed by the GW 2 and the ECU 3b that belong to the cluster PNC 2. In the following description, an operation of “waking up the GW 2 and 3a that belong to the cluster PNC 1” is also referred to as simply “waking up the cluster PNC 1”. The same expression is also used for the other cluster PNC 2.

### 1-5. Operation Modes

The operation modes and wake-up operations of the GW 2 and the ECUs 3 will now be described.

The operation modes of the GW 2 and the ECUs 3 include a normal mode and a sleep mode. In the normal mode, the GW 2 and the ECUs 3 are in an operating state and are capable of controlling a controlled object and communicating with other devices out of the GW 2 and ECUs 3. The sleep mode is a state in which the GW 2 and ECUs 3 are stopped, except for some functions of the communication I/Fs 11a, 11b, 13a, and 13b.

According to CAN, when some clusters are woken up by a partial networking function, a frame specifying the cluster(s) to be woken up is transmitted on the communication buses 12a and 12b. A wake-up request, that is, a frame specifying a cluster to be woken up, is transmitted by the ECU 3a, for example. In the case of the ECU 3a, a frame is generated using the cluster table 41. However, the transmitter of a frame is not limited to the ECU 3a, and the GW 2 and the ECU 3b may also transmit a frame.

The communication I/Fs 11a and 11b of the GW 2 and the communication I/Fs 13a and 13b of any ECUs 3 that are in the sleep mode receive a frame and determine whether a cluster to which that device belongs is specified in the frame. If a cluster to which that device belongs is not specified, the GW 2 and ECUs 3 remain as is in the sleep mode. If a cluster to which the present device belongs is specified, the communication I/Fs 11a, 11b, 13a, and 13b interrupt the control unit (processor) and instruct the control unit to switch from the sleep mode to the normal mode. By doing so, the GW 2 and the ECU 3 that belong to the specified cluster wake up.

On the other hand, the GW 2 and an ECU 3 transition from the normal mode to the sleep mode when processing related to a function performed by such devices ends. In other words, the GW 2 and the ECUs 3, which have received a frame and transitioned from the sleep mode to the normal mode, are configured to transition to the sleep mode after a series of processes has ended. Accordingly when a frame is no longer being received, the GW 2 and the ECUs 3 transition to the sleep mode and thereafter remain in the sleep mode. The GW 2 and ECUs 3 may be configured to transition to the sleep mode after a predetermined period has elapsed following the end of the series of processes.

The transition to the sleep mode of the GW 2 and the ECUs 3 is not limited to when frames are no longer being received. As one example, the GW 2 and the ECUs 3 may be configured to transition to the sleep mode when a frame including an instruction to transition to the sleep mode has been received.

When transitioning from the sleep mode to the normal mode, the GW 2 and the ECUs 3 operate on a predetermined clock. In the sleep mode, the clock stops and the GW 2 and the ECUs 3 stop. For this reason, in the normal mode, the power consumption by the GW 2 and the ECUs 3 is large. On the other hand, in the sleep mode, the power consumption by the GW 2 and the ECUs 3 is small. Note that the communication I/Fs 11a, 11b, 13a, and 13b operate in the normal mode. In the sleep mode, some functions of the communication I/Fs 11a, 11b, 13a, and 13b are stopped.

### 1-7. Functions of GW

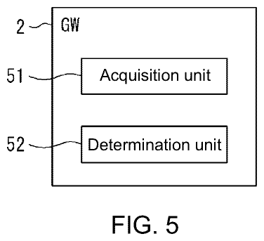

FIG. 5 is a functional block diagram depicting one example of the functions of the GW according to the first embodiment.

The GW 2 includes the functions of an acquisition unit 51 and a determination unit 52. The acquisition unit 51 and the determination unit 52 are functions of the MCU 21. These functions of the acquisition unit 51 and the determination unit 52 are realized by the MCU 21 executing a control program.

### 1-7-1. Acquisition Unit

The acquisition unit 51 acquires first information for determining first execution start timing, which is the timing at which the first function executed by a first vehicle-mounted control apparatus and the second vehicle-mounted control apparatus is to start, and a first execution period, which is the period at which the first function is executed, and second information for determining second execution start timing, which is the timing at which a second function executed by the first vehicle-mounted control apparatus and a third vehicle-mounted control apparatus is to start, and a second execution period, which is the period at which the second function is executed.

In more detail, the first function executed by the first vehicle-mounted control apparatus and the second vehicle-mounted control apparatus is for example a periphery monitoring function executed by an image ECU (the ECU 3a) that acquires images from an image sensor that captures the periphery of the vehicle, and the GW 2 that recognizes people from the acquired images. As one example, the second function executed by the first vehicle-mounted control apparatus and the third vehicle-mounted control apparatus is a vehicle information gathering function in which the GW 2 receives predetermined vehicle information from predetermined ECUs via the communication buses 12a and 12b, and the ECU 3b, which is a TCU, uploads the vehicle information to a server outside the vehicle. The periphery monitoring function, which is the first function, and the vehicle information gathering function, which is the second function, are executed by the GW 2, which is a shared first vehicle-mounted control apparatus.

The execution period is a period at which a function, such as the periphery monitoring function, is repeatedly executed. The periphery monitoring function is executed by an image ECU that acquires images from an image sensor and the GW 2 that recognizes people from the acquired images. The ECU 3a, which is an image ECU, wakes up at each execution period to execute the periphery monitoring function. Awake up operation wakes up the ECU 3a due to a timer included in the ECU 3a issuing an interrupt to the ECU 3a itself. A value of 3 ms for example is set in this timer. The periphery monitoring function is executed every 3 ms, and in this case, 3 ms is a specific example of the “execution period”.

The execution start timing is the timing at which execution of a function starts. The execution start timing is the point at which the time indicated by the execution start timing has elapsed from a reference time. As one example, if a master clock, which controls the reference time used as a reference for the entire vehicle, is located at any of the GW, an ECU, or a server outside the vehicle and the timer of each ECU is synchronized to this master clock, the reference time referred to here is the time at which the master clock started. Alternatively, in a case where a plurality of functions are being executed, the reference time is the time at which execution of an arbitrary function A out of the plurality of functions was started.

In more detail, when the periphery monitoring function and the vehicle information gathering function are executed, as one example, the timer of the GW 2, which executes the vehicle information gathering function, is started in synchronization with the start of execution of the periphery monitoring function by the ECU 3a. The execution start timing of the vehicle information gathering function is set in the timer of the GW 2. After the time indicated by the execution start timing has elapsed, the timer of the GW 2 starts the vehicle information gathering function, such as by issuing an interrupt to the GW 2 itself. By doing so, execution of the vehicle information gathering function will start after the time indicated by the execution start timing of the vehicle information gathering function has elapsed, with the time at which execution of the periphery monitoring function started as a reference.

The first information is information for determining the first start timing, which is the timing at which a function is started, and the first execution period, which is the period at which that function is executed. The second information is information for determining the second start timing, which is the timing at which a function is started, and a second execution period, which is the period at which that function is executed.

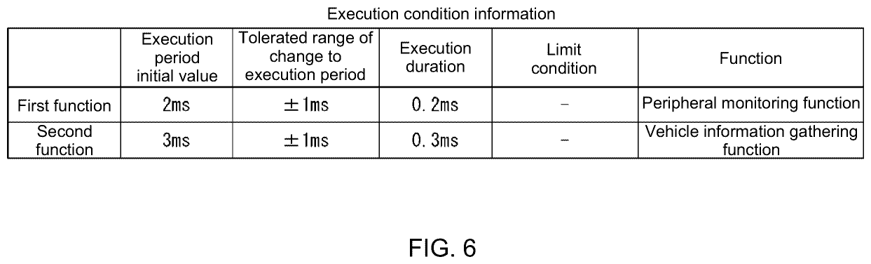

FIG. 6 is a diagram depicting one example of information for determining the execution start timing and the execution period. Hereinafter, the first information for determining the first execution start timing and the first execution period and the second information for determining the second execution start timing and the second execution period may be collectively referred to as “execution condition information”. The first execution start timing and the second execution start timing may be collectively referred to as “execution start timing,” and the first execution period and the second execution period may be collectively referred to as “execution periods”.

The execution condition information is determined by taking each function into consideration, and as one example is information in a table format like that depicted in FIG. 6. The execution condition information lists, for each function, information for determining the execution start timing and the execution period of that function in association with an identifier that identifies the function. The listed information includes, for example, the initial value of the execution period, a tolerated range for changing the execution period, the execution duration, and any limit conditions.

The initial value of the execution period for a function to be executed is an initial value of a typical execution period that is required for that function to be realized. The initial value of the execution period may be 2 ms or 3 ms, for example. The tolerated range for changing the execution period is the range in which changing the execution period from the initial value is tolerated. The execution period required to realize a function to be executed has a certain width, and the tolerated range of change in the execution period indicates how much the execution period may be changed from its initial value. The tolerated range for changing the execution period is ±1 ms, for example. Note that while the initial value and the tolerated range of change are described here, it is also possible to specify minimum and maximum values for the execution period. The execution duration is the time from when a function executed in a predetermined execution period starts to when the function ends. The execution duration can take values such as 0.2 ms or 0.3 ms, for example.

A limit condition is a condition that limits the execution of a function. Limit conditions for limiting the execution of a function are specified as necessary for that particular function, and in some cases are not specified. A limit condition may be specified for example as information indicating “parallel operation prohibited”, so that the function has a high priority and is not executed in parallel with other functions. Alternatively, if execution of a second function starts after the execution of a first function has been completed and the result of that first function has been received, a limit condition of the second function may be defined as information indicating that the second function is executed after the first function has been completed. Note that if no limit condition is specified, the execution start timing and the execution period are determined based on the initial value of the execution period and the tolerated range of change to the execution period.

The acquisition unit acquires the execution condition information. The execution condition information is stored in the non-volatile memory of the memory 23 of the GW 2, for example. The control unit 22 reads the execution condition information stored in the memory 23 and acquires the execution condition information. The execution condition information may be stored for each function for example by ECUs that execute that function. In more detail, the execution condition information for the periphery monitoring function may be stored by the ECU 3a, which is the image ECU, and the execution condition information for the vehicle information gathering function may be stored by the GW 2. In this case, the acquisition unit 51 may acquire the execution condition information for the periphery monitoring function from the ECU 3a and the execution condition information for the vehicle information gathering function from the GW 2. The execution condition information may be stored in a server outside the vehicle. In this case, the acquisition unit 51 accesses the server via a communication network to acquire the necessary execution condition information. If the scheduling apparatus is realized as a server, the acquisition unit 51 acquires the execution condition information directly from within the scheduling apparatus without communication via a communication network.

### 1-7-2. Determination Unit

The determination unit 52 determines, based on the first information and the second information, the first execution start timing, the first execution period, the second execution start timing, and the second execution period that minimize the total power consumption of the first vehicle-mounted control apparatus, the second vehicle-mounted control apparatus, and the third vehicle-mounted control apparatus.

The GW and each ECU consume a predetermined amount of power to execute the predetermined functions. As one example, the GW 2 consumes 20 W (watts), the ECU 3a consumes 5 W, and the ECU 3b consumes 10 W. The power consumption referred to here does not need to be the actual power consumption, and may be relative values of the power consumption of respective ECUs. This is because relative values can still be compared with each other. As examples, GW 2 is 4, ECU 3a is 1, and ECU 3b is 2.

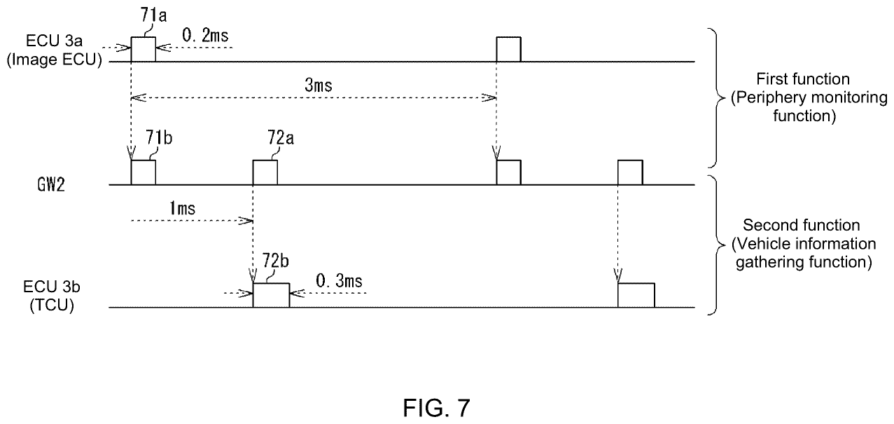

FIG. 7 is a diagram depicting the operation when two functions are executed in parallel. Periphery monitoring using an image sensor is executed by the ECU 3a and the GW 2. The ECU 3a executes a function of acquiring images from an image sensor that captures the periphery of the vehicle and transmitting frames including the acquired images to the GW 2. This operation is indicated as part 71a in FIG. 7. The GW 2 receives a frame including an image transmitted from the image ECU and the GW 2 wakes up due to the reception of the frame. After waking up, the GW 2 executes a function of recognizing people from the received image. This operation is indicated as part 71b in FIG. 7. As depicted in FIG. 7, as one example the periphery monitoring function is executed every 3 ms and continues for 0.2 ms.

On the other hand, the vehicle information gathering function is executed by the GW 2 and the ECU 3b. The GW 2 executes a function of receiving predetermined vehicle information from predetermined ECUs via the communication buses 12a and 12b, and transmitting a frame including the received vehicle information to the ECU 3b. This operation is indicated as part 72a in FIG. 7. The ECU 3b receives a frame including the vehicle information transmitted from the GW 2, and the ECU 3b wakes up due to reception of the frame. After waking up, the ECU 3b executes a function of uploading a frame including the received vehicle information to a server outside the vehicle. This operation is indicated as part 72b in FIG. 7. As depicted in FIG. 7, as one example the vehicle information gathering function is executed for 0.3 ms every 3 ms, 1 ms after the execution of the periphery monitoring function.

The total power consumption is the sum of the power consumed by each ECU. The determination unit calculates, based on the first execution duration and the second execution duration, the power consumption of each of the first vehicle-mounted control apparatus, the second vehicle-mounted control apparatus, and the third vehicle-mounted control apparatus, and determines the execution start timing and the execution period that minimize the total power consumption. In more detail, the total power consumption is obtained by multiplying the power consumption of each ECU by the execution duration, summing the results, and dividing by the execution period. If the execution periods of the first function and the second function differ, the total power consumption is calculated using the least common multiple of the execution period of the first function and the execution period of the second function. In this way, power consumption can be easily calculated without actually measuring the voltages and currents of the ECUs.

As one example, assume that power consumption is 20 W (watts) for the GW 2, 5 W for the ECU 3a, and 10 W for the ECU 3b. When the periphery monitoring function and the vehicle information gathering function are executed, the total power consumption of the GW 2, the ECU 3 a, and the ECU 3b is 4.7 W (watts).

Total power consumption=(0.2*5+(0.2+0.3)*20+0.3*10)/3

=4.7 W (watts)

Next, the determination unit 52 determines the first execution start timing, the first execution period, the second execution start timing, and the second execution period that minimize the total power consumption.

In more detail, the determination unit 52 calculates the total power consumption for example by sequentially changing the execution start timing of the vehicle information gathering function within the range of the execution period. The determination unit 52 then determines, as the execution start timing, a period from when execution of the periphery monitoring function that results in the smallest total power consumption starts to the start of the vehicle information gathering function, whose execution is started with a delay. As one example, the total power consumption when execution of the vehicle information gathering function starts a delay of 0 ms after execution of the periphery monitoring function is calculated. In this case, since the GW 2 executes the periphery monitoring function and the vehicle information gathering function simultaneously, the execution duration of GW 2 is 0.3 ms. The total power consumption in this case is

Total power consumption=(0.2*5+0.3*20+0.3*10)/3

=3.3 W (watts)

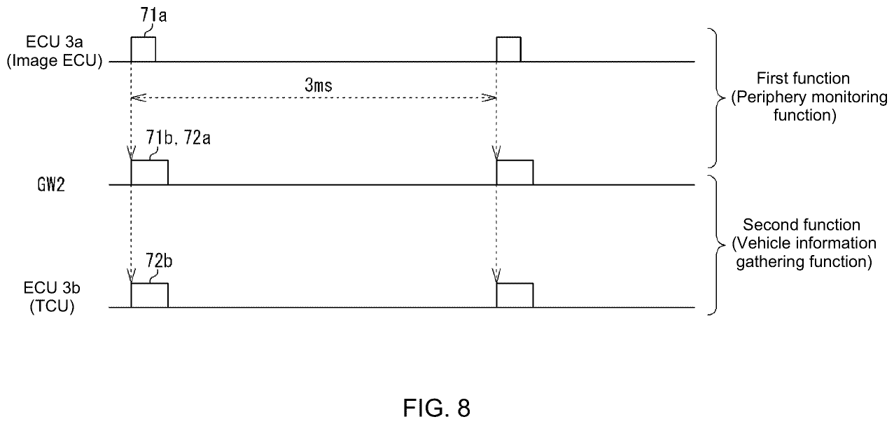

FIG. 8 is a diagram depicting the operation when two functions are executed simultaneously. As depicted in FIG. 8, when the two functions, that is, the periphery monitoring function and the vehicle information gathering function, are executed in an overlapping manner, the periods during which the GW 2, which commonly executes the two functions, operates will overlap, which reduces the actual execution duration of the GW 2. By doing so, the total power consumption is reduced. The minimum power consumption occurs when the period during which the two functions are executed in an overlapping manner is the shortest.

The first information includes a first execution duration which is the time from the start of the first function to the end of the first function in the first execution period, and the second information includes a second execution duration which is the time from the start of the second function to the end of the second function in the second execution period. In more detail, as depicted in FIG. 6, the execution condition information includes an execution duration, which is the time from when a cyclically executed function starts to when the function ends. As one example, in the case of the periphery monitoring function, the execution duration is 0.2 ms, for example. In the case of the vehicle information gathering function, the execution duration is 0.3 ms, for example. In this way, the execution duration of the periphery monitoring function is shorter than the execution duration of the vehicle information gathering function. For this reason, there is a certain width to the narrowest period during which execution of the periphery monitoring function overlaps execution of the vehicle information gathering function. In more detail, execution of the vehicle information gathering function starts after execution of the periphery monitoring function has started, with the execution start timing of the vehicle information gathering function being −0.1 ms to 0 ms. When the execution start timing of the vehicle information gathering function is between −0.1 ms and 0 ms, the period during which the two functions are executed in an overlapping manner is fixed at 0.3 ms. With execution durations indicated like this, the execution start timing can be flexibly determined.

The above describes the case where the execution period of the periphery monitoring function and the execution period of the vehicle information gathering function are the same at 3 ms. The function of the determination unit 52 for an example where the execution period of the periphery monitoring function is 2 ms and the execution period of the vehicle information gathering function differs at 3 ms will now be described.

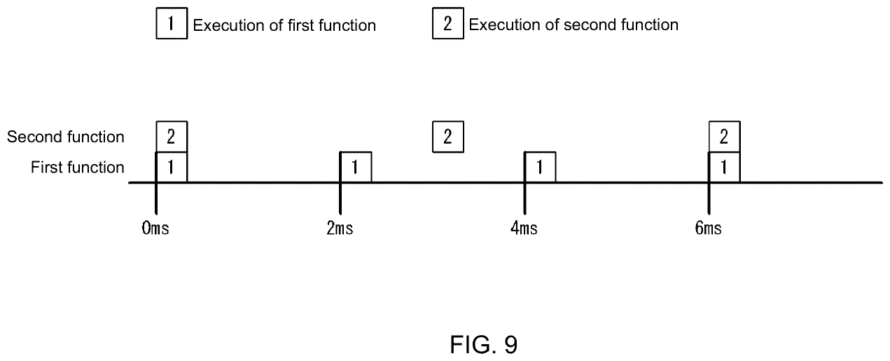

FIG. 9 is a diagram depicting the operation when two functions are executed with different execution periods. As depicted in FIG. 9, even if the execution start timing of the vehicle information gathering function is determined to be 0 ms so that execution of the vehicle information gathering function can overlap a first iteration of the periphery monitoring function, when the periphery monitoring function is executed for a second iteration, the vehicle information gathering function will not be executed, which means that power consumption is not suppressed.

For this reason, the determination unit 52 determines a first setting range, which is the range in which the first execution period should be limited based on the first information, determines the first execution start timing and the first execution period based on this first setting range, determines a second setting range, which is the range in which the second execution period should be limited based on the second information, and determines the second execution start timing and the second execution period based on this second setting range. The first setting range may be determined based on the first period initial value, which is an initial value of the period at which the first function is executed, and the first tolerated range, which is a range within which a change from the first period initial value is tolerated, and the second setting range may be determined based on a second period initial value, which is an initial value of the period at which the second function is executed, and a second tolerated range, which is a range within which a change from the second period initial value is tolerated. Note that the first setting range and the second execution range may be referred to as the “setting range”.

The first setting range is a range to which the first execution period should be limited. The first setting range is determined based on the first information. The first execution start timing and the first execution period are then determined based on the first setting range. By doing so, the first execution start timing and the first execution period can be flexibly determined within the first setting range. The same applies to the second setting range. As a result, when the periphery monitoring function is executed for a first iteration, the vehicle information gathering function can be executed in an overlapping manner, and when the periphery monitoring function is executed for a second or later time, the vehicle information gathering function can also be executed, which makes it possible to suppress the power consumption.

FIG. 6 is a diagram depicting example conditions for determining the execution start timing and the execution period. As depicted in FIG. 6, in the case of the periphery monitoring function, the initial value of the execution period is 2 ms, and the tolerated range of change in the execution period (that is, the range in which a change from the initial value is tolerated) is ±1 ms. Accordingly, the setting range for the periphery monitoring function is 1 ms to 3 ms, so that determining the execution period in the range of 1 ms to 3 ms is tolerated. On the other hand, for the vehicle information gathering function, the initial value of the execution period is 3 ms and the tolerated range for changing the execution period (the range in which a change from the initial value is tolerated) is ±1 ms. Accordingly, the setting range for the vehicle information gathering function is 2 ms to 4 ms, so that determining the execution period in the range of 2 ms to 4 ms is tolerated. As a result, the tolerated range of the periphery monitoring function and the tolerated range of the vehicle information gathering function overlap in a range of 2 ms to 3 ms.

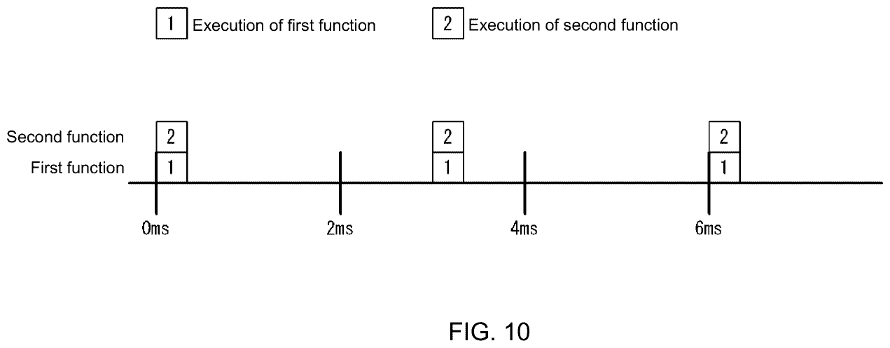

FIG. 10 is a diagram depicting an operation where two functions are executed simultaneously with the same execution period. As depicted in FIG. 10, by setting the execution period to 3 ms, for example, it is possible to have execution of the vehicle information gathering function overlap execution of the periphery monitoring function during the first iteration and also have the vehicle information gathering function executed when the periphery monitoring function is being executed during the second and later iterations.

However, the total power consumption is not the same for the entire range of execution period from 2 ms to 3 ms. As one example, for an example where the periphery monitoring function and the vehicle information gathering function are executed, the total power consumption is 4.5 W when the execution period is 2 ms.

$$Total power consumption = ( 0.2 * 5 + 0.3 * 20 + 0.2 * 10 ) / 2 = 4.5 W ( watts )$$

The total power consumption is 3.3 W when the execution period is 3 ms.

$$Total power consumption = ( 0.2 * 5 + 0.3 * 20 + 0.2 * 10 ) / 3 = 3.3 W ( watts )$$

In this way, the total power consumption changes depending on the execution period. For this reason, the determination unit 52 needs to determine, out of the overlapping setting ranges, the execution period and the execution timing that will minimize the total power consumption. To determine the execution period and execution timing that will minimize the total power consumption, as one example, the determination unit 52 sequentially changes the execution period within the setting range, also sequentially changes the execution start timing within the range of the changed execution period, calculates the total power consumption for each combination, and adopts a combination of the execution period and the execution start timing that results in the minimum total power consumption.

Note that the method for determining the execution period is not limited to this and various other methods, such as a gradient descent method, can be used.

### 1-8. Operation of Scheduling Apparatus

The following describes the operation of a scheduling apparatus according to the first embodiment. The scheduling apparatus starts operating when, for example, a new function has been introduced into the vehicle-mounted system 1. The scheduling apparatus also starts operating when a new ECU has been added to the vehicle-mounted system 1 and, together with this, a new function has been introduced into the vehicle-mounted system 1. Alternatively, the scheduling apparatus also starts operating when an existing function is updated.

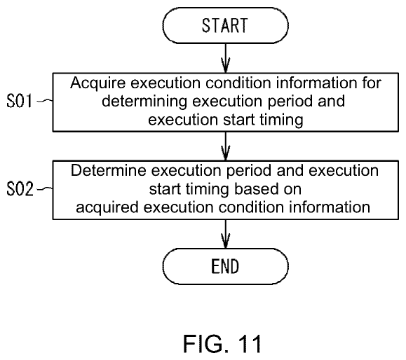

FIG. 11 is a flowchart depicting an example of the operation of a scheduling apparatus according to the first embodiment.

### 1-8-1. Step S01

The acquisition unit 51 acquires first information for determining the first execution start timing, which is the timing at which a first function executed by the first vehicle-mounted control apparatus and the second vehicle-mounted control apparatus is started, and a first execution period, which is the period at which the first function is executed, and second information for determining the second execution start timing, which is the timing at which a second function executed by the first vehicle-mounted control apparatus and the third vehicle-mounted control apparatus is started, and a second execution period, which is the period at which the second function is executed (step S01). That is, the acquisition unit 51 acquires the execution condition information.

As one example, the execution condition information is stored in the non-volatile memory of the memory 23 of the GW 2. The control unit 22 reads out and acquires the execution condition information stored in the memory 23. The execution condition information may be stored for each function by an ECU that executes that function, for example. In more detail, the execution condition information for the periphery monitoring function may be stored by the ECU 3a, which is the image ECU, and the execution condition information for the vehicle information gathering function may be stored in the GW 2. In this case, the acquisition unit 51 acquires the execution condition information for the periphery monitoring function from the ECU 3a and acquires the execution condition information for the vehicle information gathering function from the GW 2. The execution condition information may be stored in a server outside the vehicle. In this case, the acquisition unit 51 accesses the server via a communication network to acquire the necessary execution condition information. If the scheduling apparatus is realized as a server, the acquisition unit 51 acquires the execution condition information directly within the scheduling apparatus itself, without communicating via a communication network. After the acquisition unit 51 has acquired the execution condition information, the processing proceeds to step S02.

### 1-8-2. Step S02

The determination unit 52 determines, based on the first information and the second information, the first execution start timing, the first execution period, the second execution start timing, and the second execution period that minimize the total power consumption of the first vehicle-mounted control apparatus, the second vehicle-mounted control apparatus, and the third vehicle-mounted control apparatus (step S02).

As a detailed example, the determination unit 52 scans execution periods and execution start timings within the setting range, and uses and determines the execution period and execution start timing that result in the smallest total power consumption. After the determination unit 52 has determined the execution start timing and the execution period, the scheduling apparatus ends its operation.

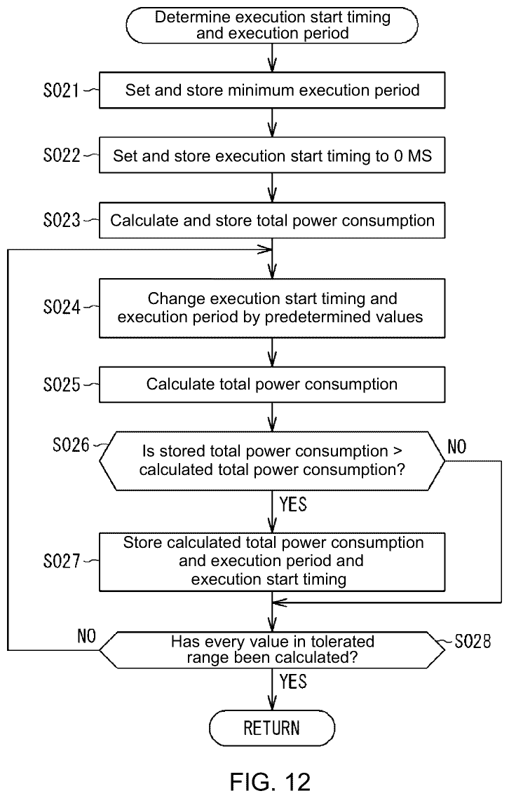

FIG. 12 is a flowchart depicting one example of a routine for determining the execution start timing and the execution period. The routine for determining the execution start timing and the execution period depicted in FIG. 12 is described below.

### Step S021

In the routine that determines the execution start timing and the execution period, the determination unit 52 first sets the execution period at the minimum value in the setting range and stores the execution period in the memory 23. After storing the execution period, the determination unit 52 proceeds to step S022.

### Step S022

Next, the determination unit 52 sets the start timing to a predetermined value, for example, 0, and stores the set value in the memory 23. After storing the set value, the determination unit 52 proceeds to step S023.

### Step S023

Next, the determination unit 52 calculates the total power consumption based on the set execution period and execution start timing, and stores the total power consumption in the memory 23. After storing the total power consumption, the determination unit 52 proceeds to step S024.

### Step S024

Next, the determination unit 52 changes the execution period and the execution start timing by predetermined values. This change in value is performed by changing any one of the first execution period, the first execution start timing, the second execution period, and the second execution start timing by a predetermined value so as to cover the setting range. As one example, the predetermined value is the greatest common divisor for the first execution period and the second execution period. When the first execution period is 2 ms and the second execution period is 3 ms, the predetermined step value is 1 ms. The predetermined step value is not limited to this and may be shorter, for example, 0.1 ms. After changing the first execution period, the first execution start timing, the second execution period, and the second execution start timing, the determination unit 52 proceeds to step S025.

### Step S025

Next, the determination unit 52 calculates the total power consumption based on the execution period and the execution start timing that have been changed. After calculating the total power consumption, the determination unit 52 proceeds to step S026.

### Step S026

Next, the determination unit 52 compares the total power consumption that has just been calculated (in step S025) with the total power consumption stored in the memory 23. If the calculated total power consumption is smaller than the total power consumption stored in the memory 23 (YES in step S026), the determination unit 52 proceeds to step S027. On the other hand, if the calculated total power consumption is equal to or greater than the total power consumption stored in the memory 23 (NO in step S026), the determination unit 52 proceeds to step S028.

### Step S027

Next, the determination unit 52 stores the calculated total power consumption (that is, the total power consumption calculated in step S025), and the execution period and the execution start timing at such time in the memory 23. After storing the values, the determination unit 52 proceeds to step S028.

### Step S028

Next, the determination unit 52 determines whether the execution period and the execution start timing have covered the setting range. If it has been determined that the execution period and execution start timing do not cover the setting range, the processing returns to step S024, and the total power consumption is calculated again while changing the execution period and execution start timing. On the other hand, on determining that the execution period and execution start timing have covered the setting range, the determination unit 52 returns to the original routine.

### 1-9. Summary

When the determination unit 52 executes steps S021 to S028, the determination unit 52 calculates the total power consumption while changing the execution period and execution start timing within the setting range to a first setting range and a second setting range, and every time a total power consumption that is smaller than the total power consumption stored in the memory 23 is calculated, the determination unit 52 stores this total power consumption and the execution period and execution start timing at such time in the memory 23. As a result, when the execution of steps S021 to S08 has been completed, the minimum total power consumption and the execution start timing and the execution period corresponding to such total power consumption are stored in the memory 23.

Accordingly by executing steps S01 to S02, the scheduling apparatus can determine the first execution start timing and the first execution period that minimize the total power consumption. By doing so, it is possible to determine a schedule that can suppress the power consumption of the vehicle-mounted control apparatuses even if functions are added to the vehicle-mounted system 1 and the number of functions executed in parallel increases.

Note that the above describes a case where the scheduling apparatus is implemented in a GW. However, the scheduling apparatus is not limited to a GW and may be implemented in a server outside the vehicle. When implemented in a GW, there is no need to transmit and receive the execution condition information, and the determined execution start timing and execution period via a communication network, so that the execution start timing and the execution period can be determined in a short time. On the other hand, when the processing is implemented by a server outside the vehicle, since the execution start timing and execution period are determined by the server outside the vehicle, there is an advantage of not placing a load on vehicle hardware resources, such as the memory area of the GW. Note that the server outside the vehicle may be an OTA (Over the Air) server whose software is updated via a wireless network.

### 2. Second Embodiment

A second embodiment of the present disclosure will now be described in detail with reference to the accompanying drawings.

In the second embodiment, the scheduling apparatus further includes a setting unit as a functional block, but other parts are the same as in the first embodiment. Configurations that are the same as in the first embodiment have been assigned the same reference numerals, and description of the same configurations, functions, and operations will be omitted.

### 2-1. Configuration of Scheduling Apparatus

The configuration of the scheduling apparatus according to the second embodiment is the same as in the first embodiment.

### 2-2. Problem to be Solved by the Present Embodiment

In this second embodiment, a schedule that can reduce the power consumption of vehicle-mounted control apparatuses is set in the vehicle-mounted system 1.

### 2-3. Functions of Scheduling Apparatus

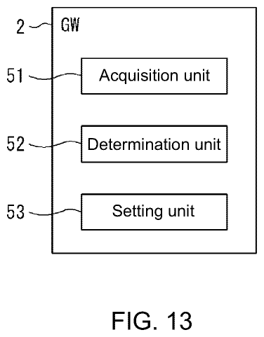

FIG. 13 is a functional block diagram depicting example functions of the scheduling apparatus according to the second embodiment. In this second embodiment, the scheduling apparatus 2 further includes a setting unit 53 as a functional block.

### 2-3-1. Setting Unit

The setting unit sets the first execution start timing and the first execution period determined by the determination unit in the first vehicle-mounted control apparatus and the second vehicle-mounted control apparatus, and sets the second execution start timing and the second execution period determined by the determination unit in the first vehicle-mounted control apparatus and the third vehicle-mounted control apparatus.

In more detail, the first execution start timing, the first execution period, the second execution start timing, and the second execution period determined by the determination unit 52 are stored in the memory 23, for example. The setting unit 53 transmits the first execution start timing, the first execution period, the second execution start timing, and the second execution period stored in the memory 23 to the ECUs that execute the functions via the communication I/Fs 13a and 13b and the communication buses 12a and 12b by placing information indicating the first execution start timing, the first execution period, the second execution start timing, and the second execution period in a frame. Each ECU that receives the transmitted frame extracts the information indicating the execution period and the execution start timing included in the frame and executes the function based on the extracted execution period and execution start timing.

When the function is to be executed by an apparatus, information indicating the first execution start timing, the first execution period, the second execution start timing, and the second execution period is set in a predetermined location in that apparatus. The apparatus then executes the function based on the first execution start timing, the first execution period, the second execution start timing, and the second execution period in the set predetermined location. By doing so, the setting unit 53 can set the execution period and the execution start timing of each vehicle-mounted control apparatus.

### 2-4. Operation of Scheduling Apparatus

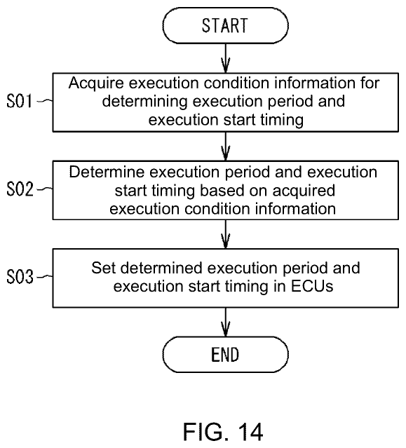

FIG. 14 is a flowchart depicting an example operation of the scheduling apparatus according to the second embodiment. The operation of the scheduling apparatus according to the second embodiment is described below. Since the operations from step S01 to step S02 are the same as in the first embodiment, description thereof is omitted. The second embodiment differs from the first embodiment in that in step S03, the setting unit 53 sets the execution period and the execution start timing in an ECU. After the determination unit 52 has determined the first execution start timing, the first execution period, the second execution start timing, and the second execution period, the scheduling apparatus proceeds to step S03.

### 2-4-1. Step S03

The setting unit 53 sets the first execution start timing and the first execution period determined by the determination unit 52 in the first vehicle-mounted control apparatus and the second vehicle-mounted control apparatus, and sets the second execution start timing and the second execution period determined by the determination unit in the first vehicle-mounted control apparatus and the third vehicle-mounted control apparatus.

In more detail, the setting unit 53 transmits the first execution start timing, the first execution period, the second execution start timing, and the second execution period stored in the memory 23 to the ECUs that execute a function, via the communication I/Fs 13a and 13b and the communication buses 12a and 12b by placing information indicating the execution start timing and the execution period in a frame. When a function is to be executed by the scheduling apparatus itself, information indicating the execution start timing and execution period is set at a predetermined location in this apparatus.

In the case of the periphery monitoring function and the vehicle information gathering function, the setting unit 53 sets the first execution period and the first execution start timing in the GW 2 and the ECU 3a, and sets the second execution start timing and the second execution period in the GW 2 and the ECU 3b. The ECU 3a executes the periphery monitoring function based on the set first execution start timing and first execution period, and the ECU 3b executes the vehicle information gathering function based on the set second execution start timing and second execution period. The GW 2 executes the periphery monitoring function based on the first execution start timing and the first execution period, and executes the vehicle information gathering function based on the second execution start timing and the second execution period simultaneously with the execution of the periphery monitoring function. After the setting unit 53 sets the execution period and execution start timing in the GW 2, the ECU 3a, and the ECU 3b, the operation of the scheduling apparatus ends.

### 2-4-2. Summary

The GW 2, the ECU 3a, and the ECU 3b execute the functions based on the first execution start timing, the first execution period, the second execution start timing, and the second execution period that have been determined by the determination unit 52 so as to minimize the total power consumption. By doing so, even when a function has been added to the vehicle-mounted system 1 and the number of functions executed in parallel increases, it is possible to suppress the power consumption of the vehicle-mounted control apparatuses.

### 3. Third Embodiment

A third embodiment of the present disclosure will now be described in detail with reference to the accompanying drawings.

The scheduling apparatus according to the third embodiment has the same functional blocks as the first embodiment. However, the functions and operations of the determination unit 52 partially differ. Configurations that are the same as in the first embodiment have been assigned the same reference numerals, and description of the same configurations, functions, and operations will be omitted.

### 3-1. Configuration of Scheduling Apparatus

The configuration of the scheduling apparatus according to the third embodiment is the same as in the first embodiment.

### 3-2. Problem to be Solved by the Present Embodiment

As one example, there are cases where a first function has high priority and it is necessary to prevent the first function from being executed in parallel with other functions. There are also cases where it is necessary to start the execution of a second function after the execution of a first function is completed and the result of the first function has been received. In such cases, it is not possible to execute the first function and the second function simultaneously in an overlapping manner even if this would minimize the total power consumption. This third embodiment attempts to reduce the power consumption of the vehicle-mounted control apparatuses even when such a limit condition is present.

### 3-3. Functions of Scheduling Apparatus

The functional blocks of the scheduling apparatus according to the third embodiment are the same as in the first embodiment depicted in FIG. 5. However, the functions of the determination unit 52 partially differ.

### 3-3-1. Determination Unit

The first information includes information indicating limit conditions that limit execution of the first function, and the determination unit determines the first execution start timing, the first execution period, the second execution start timing, and the second execution period so as to avoid limit conditions. The limit conditions may include a condition that limits execution of the first function and execution of the second function from overlapping on the time axis. The limit conditions may also include at least one of a condition relating to a restriction on hardware resources used by the first function and a condition relating to a restriction on hardware resources used by the second function.

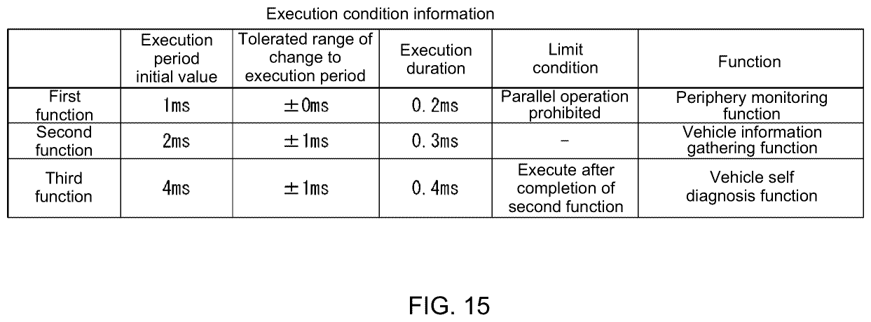

FIG. 15 is a diagram depicting one example of execution condition information including limit information. Unlike FIG. 6, the information includes a condition that is a restriction on the first function and the second function overlapping on the time axis. In more detail, a limit condition that parallel operation is prohibited is added to the first function. A third function is also added and is provided with a limit condition of the third function being executed after the second function is completed.

A limit condition that prohibits parallel operation is set when the first function has a high priority and cannot be executed in parallel with other functions, for reasons such as zero tolerance for delays. In this case, the execution start timing of the second function needs to be determined so that execution of the second function starts after the first function is executed and execution of the second function finishes before the first function is executed.

A limit condition that prohibits parallel operation may be at least one of a condition relating to a restriction on hardware resources used by the first function and a condition relating to a restriction on hardware resources used by the second function. As one example, when extremely heavy processing is performed, it would be conceivable for the entire processing capacity of the CPU of an ECU to be consumed and/or for 90% or more of the memory to be used, in which case the execution of other functions will be restricted. In the case of a function that transmits and receives large amounts of image data via a communication bus, the communication capacity of the communication bus will be consumed, which makes it difficult to further transmit and receive data on the communication bus and restricts the execution of other functions.

A limit condition of execution after completion of the second function is set in the case where execution of the third function needs to start after the execution of the second function has been completed and the result of the second function has been received. As one example, the second function may gather information on various parts of the vehicle, such as the battery voltage and the oil temperature, and the third function may execute a self-diagnosis of the vehicle based on the information on various parts of the vehicle gathered by the second function. In this case, it is necessary to determine the execution start timing of the third function so that the execution of the third function starts after execution of the second function has been completed.

In the first embodiment, the total power consumption is calculated sequentially while changing the execution start timing and execution period within the setting range, and the determination unit 52 determines the execution start timing and execution period within a setting range that minimizes the total power consumption. In the third embodiment, to avoid limit conditions such as prohibition of parallel operation and execution after completion of the second function, the determination unit 52 determines, when changing the execution start timing and execution period within the setting range, whether the execution start timing and the execution period violates a limit condition. If a limit condition is violated, the execution start timing and execution period in question are discarded, thereby avoiding the limit condition. The execution start timing and execution period are then changed to advance to the next candidate. On the other hand, if no limit condition is violated, the determination unit 52 continues the subsequent operation of calculating the total power consumption.

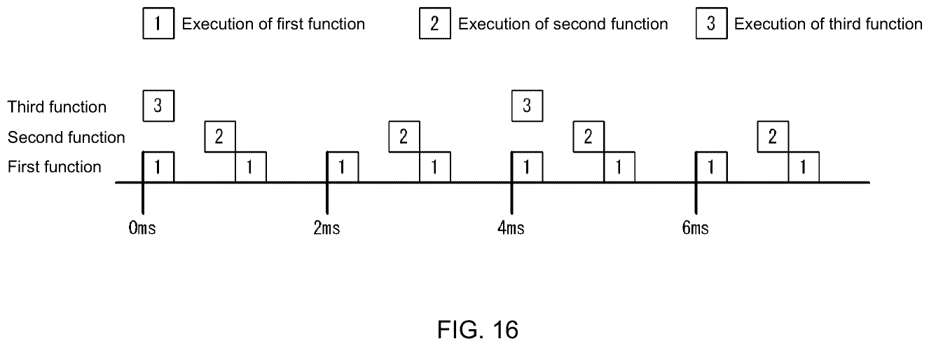

FIG. 16 is a diagram depicting an example order of execution of the first to third functions. FIG. 16 depicts a state which is after second and third functions have been added but before the scheduling apparatus according to the present disclosure has started operating. In the state depicted in FIG. 16, the execution of the first function and the execution of the third function overlap, even though the first function has a limit condition that prohibits parallel operation. The third function is also executed before execution of the second function, even though the third function has a limit condition that the third function must be executed after the second function is completed.

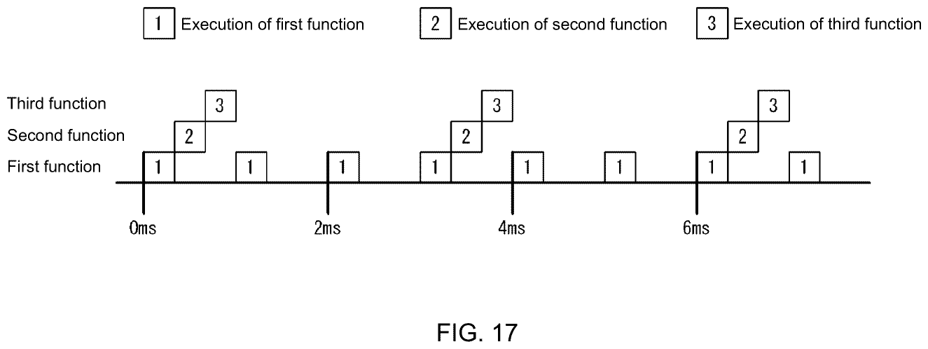

FIG. 17 is a diagram depicting one example of the order of execution of the first to third functions. FIG. 17 depicts a state where the second and third functions have been added and the operation of the scheduling apparatus according to the present disclosure has been completed. The determination unit 52 determines the execution start timing and the execution period of each function while avoiding the limit conditions. As a result, the second function is determined to have an execution start timing that is after completion of the first function and to have an execution period of 3 ms. The third function is determined to have an execution start timing that is after completion of the second function and to have an execution period of 3 ms. By doing so, it is possible to avoid the limit condition that parallel operation is prohibited for the first function and the limit condition that the third function must be executed after the second function is completed.

### 3-4. Operation of Scheduling Apparatus

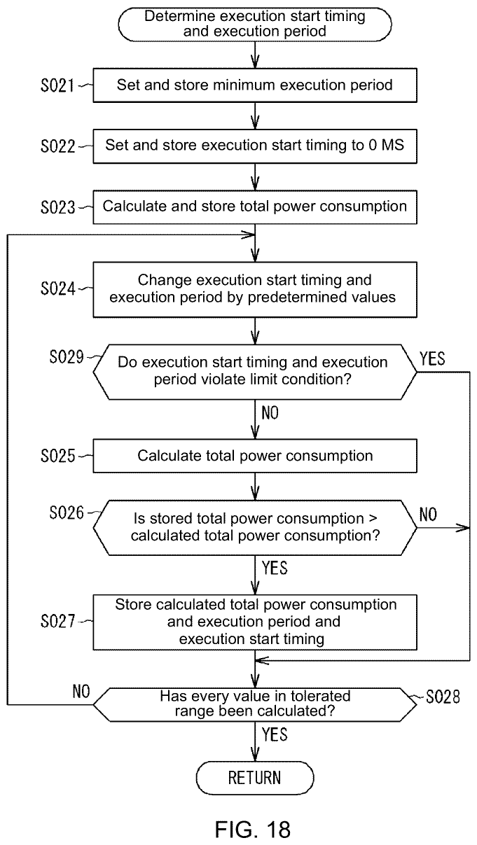

FIG. 18 is a flowchart depicting one example of the operation of the scheduling apparatus according to the third embodiment. The operation of the scheduling apparatus according to the third embodiment is described below. Since the operations from step S021 to step S028 are the same as in the first embodiment, description thereof is omitted. Unlike the first embodiment, the third embodiment determines whether the execution start timing and execution period that were changed in step S024 violate the limit conditions (step S029). After the execution start timing and the execution period have been changed by predetermined values, the determination unit 52 proceeds to step S029.

### 3-4-1. Step S029

It is determined whether the execution start timing and the execution period that were changed in step S024 violate the limit conditions (step S029). As one example, consider a case of determining the execution start timing of the second function. As depicted in FIG. 15, the execution duration of the first function is 0.2 ms. This execution duration can be acquired by referring to the execution condition information depicted in FIG. 15. Since the execution condition information includes information indicating the execution duration, even if there is a limit condition that parallel operation is prohibited, it is possible to set the execution start timing so that execution of the second function starts immediately after the first function is completed. By doing so, when the first function and the second function are executed by the same ECU, the ECU in question can remain operating and execute the second function after the first function ends without going to sleep and waking up. As a result, the processing time and power consumption can be reduced.

Since the periphery monitoring function is provided with limit information indicating that parallel operation is prohibited, for example, if the execution start timing of the vehicle information gathering function is within a range of 0.2 ms from the start of execution of the periphery monitoring function, the determination unit 52 will determine that the limit condition is violated (YES in step S029), and proceed to step S028. The determination unit 52 that has proceeded to step S028 determines whether the total power consumption has been calculated for every value within the tolerated range. Since step S027 is not executed, the present values of the execution start timing and execution period are not stored in the memory 23, and these values are not determined to be the execution start timing and the execution period with the minimum total power consumption.

On the other hand, if the execution start timing of the second function is 0.2 ms or later after the start of execution of the first function, and in other words, is after completion of the first function, as one example, 0.3 ms, it is determined that the limit condition is not violated (NO in step S029) and the processing proceeds to step S025. In step S025, the determination unit 52 calculates the total power consumption.

### 3-4-2. Summary

By doing so, the determination unit 52 determines an execution start timing and an execution period that avoid the limit condition and minimize the total power consumption. As a result, the power consumption of the vehicle-mounted control apparatus can be suppressed even when limit conditions exist.

### 4. Modification

The above describes a case where the scheduling apparatus operates using a partial network function. A partial network function is not absolutely necessary for the scheduling apparatus according to the present disclosure. Operation modes and wake up operations of a GW 2 and ECUs 3 that do not depend on a partial network function are described below.

In this case also, the operation modes of the GW 2 and the ECUs 3 include a normal mode and a sleep mode. The normal mode is a state in which the GW 2 and the ECU 3 are operating and these devices can control controlled objects and communicate with the other devices out of the GW 2 and the ECUs 3. The sleep mode is a state in which the GW 2 and the ECUs 3 are stopped, except for some functions of the communication I/Fs 11a, 11b, 13a, and 13b. When waking up an ECU, a frame including information specifying the ECU to be woken up is transmitted onto the communication buses 12a and 12b. This wake-up request, that is, the frame including information specifying the ECU to be woken up, is transmitted by the ECU 3a, for example. As one example, the ECU 3a is configured to store information indicating that the periphery monitoring function executed by the ECU 3a is executed by the ECU 3a and the GW 2. Based on this information, the ECU 3a transmits a frame including information indicating that the frame is addressed to the GW 2 as a target ECU to the GW 2. The transmitter of such frames is not limited to the ECU 3a, and the GW 2 or the ECU 3b may also transmit frames.

The communication I/Fs 11a and 11b of the GW 2 and the communication I/Fs 13a and 13b of an ECU 3 that are in the sleep mode are configured to receive a frame and determine whether the present device is specified in the frame. If the present device is not specified, the GW 2 and the ECU 3 remain as is in the sleep mode. If the present device is specified, the communication I/Fs 11a, 11b, 13a, and 13b issue an interrupt to the control unit (processor) and instruct the control unit to switch from the sleep mode to the normal mode. This wakes up the GW 2 and ECUs 3 that have been specified.

On the other hand, the GW 2 and the ECU 3 transition from the normal mode to the sleep mode when the execution of a function to which the present device relates is completed. That is, the GW 2 and the ECU 3, which have transitioned from the sleep mode to the normal mode upon receiving a frame, are configured to transition back to the sleep mode after a series of processes has been completed. Accordingly when frames are no longer being received, the GW 2 and the ECUs 3 transition to the sleep mode and then remain in the sleep mode. The GW 2 and the ECUs 3 may be configured to transition to sleep mode after a predetermined period has elapsed following the completion of a series of processes.

The transition of the GW 2 and the ECU 3 to the sleep mode is not limited to when frames are no longer being received. As one example, the ECUs 3 may be configured to transition to the sleep mode when a frame including an instruction to transition to the sleep mode has been received.

When the mode transitions from the sleep mode to the normal mode, the GW 2 and the ECUs 3 operate on a specified clock. In the sleep mode, the clock stops and the GW 2 and the ECUs 3 are stopped. Accordingly in the normal mode, the power consumption by the GW 2 and the ECUs 3 is large. On the other hand, in sleep mode, the power consumption by the GW 2 and the ECUs 3 is small.

As described above, the ECUs wake up and transition to the sleep mode through the transmission and reception of frames. The scheduling apparatus of the present disclosure can also be implemented by an ECU that performs the operations.

### APPENDIX 1

Note that the present disclosure also includes the following vehicle-mounted system.

A vehicle-mounted system including a scheduling apparatus that schedules functions executed by a plurality of vehicle-mounted control apparatuses that are capable of communicating with each other via a communication bus, and the vehicle-mounted control apparatuses connected to the communication bus, wherein the scheduling apparatus includes: an acquisition unit that acquires first information, which determines first execution start timing, which is timing at which a first function executed by a first vehicle-mounted control apparatus and a second vehicle-mounted control apparatus is started, and a first execution period, which is a period at which the first function is executed, and second information, which determines a second execution start timing, which is timing at which a second function executed by the first vehicle-mounted control apparatus and a third vehicle-mounted control apparatus is started, and a second execution period, which is a period at which the second function is executed; and a determination unit that determines, based on the first information and the second information, the first execution start timing, the first execution period, the second execution start timing, and the second execution period, which minimize total power consumption of the first vehicle-mounted control apparatus, the second vehicle-mounted control apparatus, and the third vehicle-mounted control apparatus. By doing so, it is possible to suppress the power consumption of the vehicle-mounted control apparatuses even if the number of functions executed in parallel in the vehicle-mounted system increases.

### APPENDIX 2

Note that the present disclosure also includes a vehicle described below.

A vehicle including a scheduling apparatus that schedules functions executed by a plurality of vehicle-mounted control apparatuses that are capable of communicating with each other via a communication bus, and the vehicle-mounted control apparatuses connected to the communication bus, wherein the scheduling apparatus includes: an acquisition unit that acquires first information, which determines first execution start timing, which is timing at which a first function executed by a first vehicle-mounted control apparatus and a second vehicle-mounted control apparatus is started, and a first execution period, which is a period at which the first function is executed, and second information, which determines a second execution start timing, which is timing at which a second function executed by the first vehicle-mounted control apparatus and a third vehicle-mounted control apparatus is started, and a second execution period, which is a period at which the second function is executed; and a determination unit that determines, based on the first information and the second information, the first execution start timing, the first execution period, the second execution start timing, and the second execution period, which minimize total power consumption of the first vehicle-mounted control apparatus, the second vehicle-mounted control apparatus, and the third vehicle-mounted control apparatus. By doing so, it is possible to suppress the power consumption of the vehicle-mounted control apparatuses even if the number of functions executed in parallel in the vehicle increases.

### APPENDIX 3

The embodiments disclosed above are exemplary in all respects and should not be regarded as limitations on the present disclosure. The scope of the present disclosure is not limited to the embodiments given above, is indicated by the range of the patent claims, and is intended to include all changes within the meaning and scope of the patent claims and their equivalents.

1. A scheduling apparatus for scheduling functions executed by a plurality of vehicle-mounted apparatuses that are capable of communicating with each other via a communication bus, the scheduling apparatus comprising:
an acquisition unit that acquires first information, which determines first execution start timing, which is timing at which a first function executed by a first vehicle-mounted control apparatus and a second vehicle-mounted control apparatus is started, and a first execution period, which is a period at which the first function is executed, and second information, which determines a second execution start timing, which is timing at which a second function executed by the first vehicle-mounted control apparatus and a third vehicle-mounted control apparatus is started, and a second execution period, which is a period at which the second function is executed; and
a determination unit that determines, based on the first information and the second information, the first execution start timing, the first execution period, the second execution start timing, and the second execution period, which minimize total power consumption of the first vehicle-mounted control apparatus, the second vehicle-mounted control apparatus, and the third vehicle-mounted control apparatus.

2. The scheduling apparatus according to claim 1,
further comprising a setting unit for setting the first execution start timing and the first execution period determined by the determination unit in the first vehicle-mounted control apparatus and the second vehicle-mounted control apparatus and setting the second execution start timing and the second execution period determined by the determination unit in the first vehicle-mounted control apparatus and the third vehicle-mounted control apparatus.

3. The scheduling apparatus according to claim 1,
wherein the determination unit determines a first setting range, which is a range in which the first execution period is to be limited, based on the first information, determines the first execution start timing and the first execution period based on the first setting range, determines a second setting range, which is a range in which the second execution period is to be limited, based on the second information, and determines the second execution start timing and the second execution period based on the second setting range.

4. The scheduling apparatus according to claim 3,
wherein the first setting range is decided based on a first period initial value, which is an initial value of a period at which the first function is executed, and a first tolerated range, which is a range in which a change from the first period initial value is tolerated, and
the second setting range is decided based on a second period initial value, which is an initial value of a period at which the second function is executed, and a second tolerated range, which is a range in which a change from the second period initial value is tolerated.

5. The scheduling apparatus according to claim 4,
wherein the first information includes a first execution duration that is a time from when the first function is started to when the first function ends in the first execution period, and the second information includes a second execution duration that is a time from when the second function is started to when the second function ends in the second execution period.

6. The scheduling apparatus according to claim 5,
wherein the determination unit calculates power consumption of each of the first vehicle-mounted control apparatus, the second vehicle-mounted control apparatus, and the third vehicle-mounted control apparatus based on the first execution duration and the second execution duration, and determines the first execution start timing, the first execution period, the second execution start timing, and the second execution period that minimize the total power consumption.

7. The scheduling apparatus according to claim 1,
wherein the first information includes information indicating a limit condition that limits execution of the first function, and
the determination unit determines the first execution start timing, the first execution period, the second execution start timing, and the second execution period to avoid the limit condition.

8. The scheduling apparatus according to claim 7,
wherein the limit condition includes a condition that limits execution of the first function and execution of the second function from overlapping on a time axis.

9. The scheduling apparatus according to claim 7,
wherein the limit condition includes at least one of a condition relating to a restriction on hardware resources used by the first function and a condition relating to a restriction on hardware resources used by the second function.

10. A control method for use by a scheduling apparatus that schedules functions executed by a plurality of vehicle-mounted apparatuses that are capable of communicating with each other via a communication bus,
the control method comprising:
a step of acquiring first information, which determines first execution start timing, which is timing at which a first function executed by a first vehicle-mounted control apparatus and a second vehicle-mounted control apparatus is started, and a first execution period, which is a period at which the first function is executed, and second information, which determines a second execution start timing, which is timing at which a second function executed by the first vehicle-mounted control apparatus and a third vehicle-mounted control apparatus is started, and a second execution period, which is a period at which the second function is executed; and
a step of determining, based on the first information and the second information, the first execution start timing, the first execution period, the second execution start timing, and the second execution period, which minimize total power consumption of the first vehicle-mounted control apparatus, the second vehicle-mounted control apparatus, and the third vehicle-mounted control apparatus.

11. A control program used by a scheduling apparatus that schedules functions executed by a plurality of vehicle-mounted apparatuses that are capable of communicating with each other via a communication bus,
the control program causing a computer to execute processing comprising:
a step of acquiring first information, which determines first execution start timing, which is timing at which a first function executed by a first vehicle-mounted control apparatus and a second vehicle-mounted control apparatus is started, and a first execution period, which is a period at which the first function is executed, and second information, which determines a second execution start timing, which is timing at which a second function executed by the first vehicle-mounted control apparatus and a third vehicle-mounted control apparatus is started, and a second execution period, which is a period at which the second function is executed; and
a step of determining, based on the first information and the second information, the first execution start timing, the first execution period, the second execution start timing, and the second execution period, which minimize total power consumption of the first vehicle-mounted control apparatus, the second vehicle-mounted control apparatus, and the third vehicle-mounted control apparatus.
